(19) United States
(12) Patent Application Publication
(10) Pub. No.: US 2018/0326803 A1
(43) Pub. Date: Nov. 15, 2018

(54) WHEEL CONTROL ARM WITH A FIRST AND SECOND PROFILE BODY

(71) Applicant: Benteler Automobiltechnik GmbH, Paderborn (DE)

(72) Inventors: Stephan Meyer, Bielefeld (DE); Hauke Mehner, Paderborn (DE)

(21) Appl. No.: 15/971,753

(22) Filed: May 4, 2018

(30) Foreign Application Priority Data
May 9, 2017 (DE) 10 2017 109 996.4

(51) Int. Cl. B60G 7/00

(52) U.S. Cl. CPC B60G 7/001; B60G 2206/72; B60G 2206/7101; B60G 2206/122

(57) ABSTRACT

The disclosure describes a wheel control arm for a wheel suspension in a vehicle including a flat first profile body including a first narrow end and a second narrow end, the second narrow end extends opposite the first narrow end; broadsides facing one another; a first profile body end and a second profile body end, the first profile body end includes a first bearing seat configured to fasten the wheel control arm to a vehicle component, the second profile body end includes a second bearing seat configured to fasten the wheel control arm to a wheel carrier, the first profile body is curved along a longitudinal axis of a profile body; and a second profile body, including a third profile body end and a fourth profile body end, the third profile body end includes a third bearing seat configured to fasten the wheel control arm to the vehicle component.

### CROSS-REFERENCE TO RELATED APPLICATIONS

This application claims priority to German patent application No. 10 2017 109 996.4, entitled “RADLENKER MIT EINEM ERSTEN UND ZWEITEN PROFILKÖRPER”, and filed on May 9, 2017 by the Applicant of this application. The entire disclosure of the German application is incorporated herein by reference for all purposes.

### BACKGROUND

This disclosure refers to a wheel control arm with a first and a second profile body for a wheel suspension in a vehicle, in particular, a wishbone with a first and a second profile body.

Wheel control arms for a wheel suspension of a vehicle are usually executed as sheet metal control arms, elastomer hybrid control arms or aluminum control arms in extruded form. A wheel control arm is typically executed by means of a wheel control arm body with a bearing seat for the seating of a bearing on at least one end of the wheel control arm body.

### SUMMARY

The purpose of this disclosure is the achievement of an improved wheel control arm.

This purpose is resolved by the features of the independent claims. Advantageous examples of the disclosure are the objects of the dependent claims, the description as well as the appended drawings.

This disclosure is based upon the recognition that the aforementioned purpose can be solved by a wheel control arm, in particular a two-piece wheel control arm, whereby the wheel control arm can exhibit two connectable profile bodies with a total of three bearing seats, whereby the bearing seats can exhibit different orientations, in order to fasten the wheel control arm to a vehicle component and to a wheel carrier. In this way, a mechanically solid wheel control arm is provided, which can effectively absorb the forces that occur.

According to a first aspect, this disclosure relates to a wheel control arm for a wheel suspension in a vehicle, having a first profile body, that is executed flat with a first narrow end and a second narrow end which extends opposite the first narrow end, as well as broadsides that are facing one another, a first profile body end and a second profile body end, whereby the first profile body end exhibits a first bearing seat for the fastening of the wheel control arm to a vehicle component, and whereby the second profile body end exhibits a second bearing seat for fastening of the wheel control arm to a wheel carrier, whereby the first profile body is curved along a longitudinal axis of a profile body around the first narrow end, and a second profile body, which exhibits a third profile body end and a fourth profile body end, whereby the third profile body end exhibits a third bearing seat for fastening of the wheel control arm to the vehicle component, whereby the second profile body is mechanically connected with the fourth profile body end with the broadsides of the first profile body that are facing one another.

The first profile body can form one long arm of the wheel control arm and/or the second profile body can form one short arm of the wheel control arm. In this manner, the first and second bearing seats that are arranged on the first and second profile body ends of the first profile body and the third bearing seat arranged on the third profile body are particularly advantageously spaced apart from one another in the wheel control arm. A particularly effective fastening of the wheel control arm to the vehicle component and to the wheel carrier of the vehicle can thereby be ensured.

The wheel control arm according to the disclosure exhibits particularly advantageous mechanical properties to ensure an effective absorption of force by the wheel control arm, for example, in an accident of the vehicle.

By means of the two-piece execution of the wheel control arm, a functional expansion of the wheel control arm can be achieved, whereby, in particular, the elastic and kinetic properties of the wheel control arm are adaptable by means of the type of connection between the first and the second profile body.

On top of the bearing seats, the wheel control arm can, in particular, exhibit further recesses for the attachment of further components of the vehicle and/or for the reduction of the weight of the wheel control arm.

In one example, the second profile body extends radially from the first narrow end.

A particularly effective transfer of force can hereby be ensured between the second profile body and the first profile body.

In one example, the broadsides facing one another respectively each exhibit a protruding fastening collar, whereby the fastening collars are feeing one another, whereby the fourth profile body end is inserted between the fastening collars, and whereby the first narrow end is, in particular, closed.

By means of the insertion of the fourth profile body end of the second profile body between the two fastening collars of the broadsides of the first profile body that face one another, a mechanically effective fastening of the first profile body to the second profile body can be ensured.

In one example, the first narrow end is at least partially open, and the fourth profile body end is inserted laterally in the first profile body through the open first narrow end.

By means of the insertion of the fourth of the second profile body through the first open narrow end of the first profile body, a mechanically effective fastening of the first profile body to the second profile body can be ensured.

In one example, the first narrow end is open and the second narrow end is closed, whereby the fourth profile body end is inserted laterally in the open first narrow end between the first profile body end and the second profile body end of the first profile body.

In this manner, a mechanically solid fastening of the second profile body to the first profile body is ensured.

In one example, the first profile body exhibits a U-shaped or closed profile with profile walls that face one another, which form the broadsides of the first profile body, whereby the first narrow end or the first and second narrow ends is/are formed by the front side or front sides of the profile walls that face one another.

If the first profile body exhibits a u-shaped profile, the first narrow end is completely open and thus advantageously designed for the seating of the second profile body. If the first profile body exhibits a closed profile, then the first and second narrow ends are closed and the second profile body can, in this manner, for example, respectively be inserted between a fastening collar of the broadsides of the first profile body facing one another. In particular, the manufacturing expense of the wheel control arms can advantageously be reduced insofar as the first profile body can be formed closed or in a U-shape out of semi-finished product, which can, for example, be used in the stead of an extruded profile

In one example, the first profile body is connected by interference fit, press fit and/or in a bonded manner with the second profile body.

In this manner, the first and the second profile body can effectively engage into one another, so that the seat and/or the orientation of the two profile bodies are selected in a particularly advantageous manner.

In one example, the first profile body exhibits a fastening area, whereby the fourth profile body end is inserted inside the fastening area, and whereby the fastening area exhibits at least one fastening aperture for the seating of a fastening element, in particular, a fastening bolt or fastening rivet.

A bolt and/or rivet connection between the first and the second profile body achieves a connection with a defined strength between the first and the second profile body. This can, in particular, advantageously be used to determine the characteristics of the wheel control arm when the wheel control arm is submitted to forces outside of a defined tolerance range of the wheel control arm. Alternatively, the fastening element can be designed in such a manner that a detachable connection between the first and the second profile body is provided, whereby the detachable connection disengages when there is an overload acting upon the first, or alternatively, the second profile body.

In one example, the broadsides of the first profile body taper down towards the second profile body end of the first profile body.

With a tapered shape, it is, in particular, possible to advantageously reduce the required installation space of the wheel control arms and/or the weight of the wheel control arms. Additionally, it is possible to execute a uniform transition in the width of the wheel control arm between the first and the second bearing seat, which can exhibit different diameters.

In one example, the broadsides of the first profile body are formed by profile walls that face one another, in particular flat profile walls.

In one example, the respective bearing seat or at least one of the bearing seats are formed in a sleeve-like shape.

In this manner, it is possible to achieve the advantage that rotationally symmetrical bearings, in particular bearings with a cylindrical-shaped exterior side, can be introduced in the sleeve-like shaped bearing seat.

In one example, at least one of the bearing seats or the respective bearing seat is executed with at least one protruding circumferential collar, in particular by means of a reshaping of the respective profile body ends and, in particular, forms an outer bearing collar of a bearing.

A protruding collar allows for an effective seating of the respective bearing.

In one example, the third bearing seat executes a press fit for a bearing.

The advantage that the bearing can be firmly connected with the bearing seat, can be achieved with a press fit, in particular without there being any need for additional fastening measures.

In one example, there is a pivot bearing arranged in the third bearing seat, in particular an elastomer bearing or a rubber bearing.

The advantage that the wheel control arm can be connected in a flexible and rotatable manner with a vehicle component can thus be achieved.

In one example, the pivot bearing is without an outer sleeve and the third bearing seat forms an outer sleeve of the pivot bearings.

The advantage that a bearing without a separate bearing sleeve inserted in the third bearing can be inserted in the third bearing seat can thus be achieved.

In one example, a distance between the broadsides that are facing one another along the longitudinal axis of the profile body of the first body varies, and, in particular, decreases.

The advantage that a bearing, having different thickness than that used in the second bearing seat, can be accepted in the first bearing seat is thus achieved.

In one example, a cross-sectional area of the first profile body reduces along the longitudinal axis of the profile body.

A particularly mechanically solid wheel control arm is thus formed.

In one example, the second profile body is made out of solid material or is a hollow profile body.

A hollow profile body in particular achieves the advantage of a weight reduction of the wheel control arms, whereby a body out of solid material is particularly solid.

In one example, the first profile body and/or the second profile body are made in one piece out a metal, in particular as an extruded profile, or out of plastic, in particular out of fiber reinforced plastic.

The advantage that the first and the second profile body can be manufactured out of different materials, in such a manner that the first and the second profile body can exhibit advantageous properties can thus be achieved.

In one example, the wheel control arm is a wishbone.

The wishbone can be a part of a multi-link wheel suspension, for example, a double wishbone axle and can replace a wishbone in the same. In particular, in a front axle wheel suspension, the wheel control arm can be a MacPherson front axle wishbone.

In one example, the third bearing seat is laterally free.

In one example, the third bearing seat is arranged at an angle to the first and/or second bearing seat.

In one example, the second bearing seat is designed for the seating of a ball and socket joint.

In one example, the first profile body exhibits at least one profile wall, in which one thickening is executed, in order to achieve a profile wall that is not thinned out in the event of reshaping of the at least one profile wall.

In one example, the first profile body can be connected with a wheel carrier by means of the first bearing seat and with a vehicle component of the vehicle by means of the second bearing seat and the second profile body can be connected by means of the third bearing seat with a vehicle component of the vehicle.

According to a second aspect, the disclosure relates to a method for the manufacture of a wheel control arm for a wheel suspension in a vehicle, with:

Provision of a first profile body, that is executed flat with a first narrow end and a second narrow end, which extends opposite the first narrow end, as well as with broadsides which face one another, a first profile body end and a second profile body end, whereby the first profile body end exhibits a first bearing seat for the fastening of the wheel control arm to a vehicle component, and whereby the second profile body end exhibits a second bearing seat for the fastening of the wheel control arm to a wheel carrier, whereby the first profile body is curved along a longitudinal axis of a profile body around the first narrow end;

Provision of a second profile body, which exhibits a third profile body end and a fourth profile body end, whereby the third profile body end exhibits a third bearing seat for the fastening of the wheel control arm to the vehicle component; and

Mechanical connection, in particular by means of interference and/or press fitting, of the fourth profile body end of the second profile body with broadsides of the first profile body which face one another.

In one example, in the preparation step, the first profile body is curved around the first narrow end from a straight semi-finished profile body.

In one example, the first profile body is cut laterally in the preparation step.

The first profile body can, in particular, exhibit material overhangs along the longitudinal axis of the profile body and/or an overall larger shape. The material overhangs can be employed to execute a curved shape of the first profile body, in particular without elongated and/of thinned out areas. Following a curving of the first profile body, the material overhangs can be cut off.

### BRIEF DESCRIPTION OF THE DRAWINGS

Examples of the present disclosure are further detailed in reference to the appended drawings.

FIG. 1 shows a wheel control arm according to a first example in a top view.

FIG. 2 shows a wheel control arm according to the first example in an oblique view.

FIG. 3 shows a wheel control arm according to the first example in a side view.

FIG. 4 shows a wheel control arm according to a second example in an oblique view.

FIG. 5 shows a wheel control arm according to the second example in a side view.

FIG. 6 shows a schematic representation of a method for manufacturing a wheel control arm for a wheel suspension.

### DETAILED DESCRIPTION

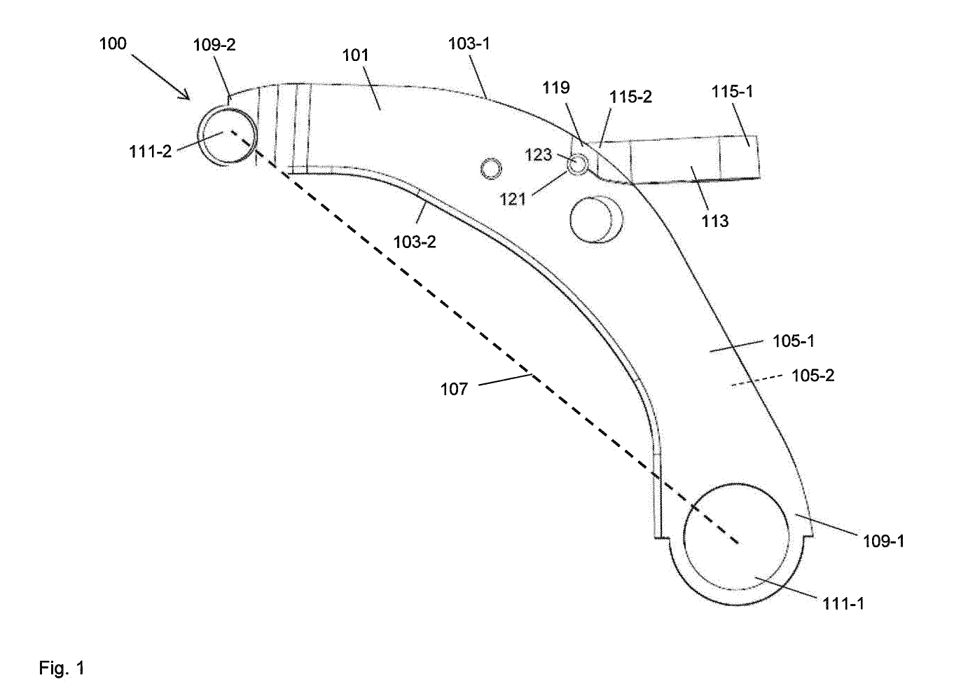

FIG. 1 shows a schematic representation of a wheel control arm 100, according to a first example, in a top view. The wheel control arm 100 is employed in a wheel suspension of a vehicle, whereby the wheel suspension exhibits a wheel carrier for the support of a wheel of the vehicle. In this manner, the wheel control arm 100, according to this disclosure, allows for an effective absorption of forces, which have an effect on the wheel control arm 100 during the driving of the vehicle.

The wheel control arm 100 exhibits a first profile body 101, which exhibits a first narrow end 103-1, and a second narrow end 103-2 which extends opposite the first narrow end 103-1. Hereby, the first narrow end 103-1 is open and the second narrow end 103-2 is closed. The first profile body 101 moreover exhibits a first broadside 105-1 and a second broadside 105-2 that faces the first broadside 105-1. In the representation selected in FIG. 1, the second broadside 105-2 is not visible.

The first profile body 101 is curved along a longitudinal axis 107 of the profile body around the first narrow end 103-1. The first profile body 101 exhibits a first profile body end 109-1 and a second profile body end 109-2, whereby the broadsides 105-1, 105-2 of the first profile body 101 of the first profile body end 109-1 taper down towards the second profile body end 109-2.

The first profile body end 109-1 exhibits a first bearing seat 111-1 for fastening of the wheel control arm 100 to a vehicle component. The second profile body end 109-2 exhibits a second bearing seat 111-2 for fastening of the wheel control arms 100 to a wheel carrier.

The wheel control arm 100 furthermore exhibits a second profile body 113, which exhibits a third profile body end 115-1 and a fourth profile body end 115-2. Hereby, the third profile body end 115-1 exhibits a third bearing seat 117-1 that is not represented in FIG. 1 for fastening of the wheel control arm 100 to the vehicle component. The fourth profile body end 115-2 of the second profile body 113 is inserted in the open first narrow end 103-1 of the first profile body 101, and is, in particular, inserted between the first profile body end 109-1 and the second profile body end 109-2 in the open first narrow end 103-1 of the first profile body 101.

The second profile body 113 is hereby, in particular, connected by interference, or press fit and/or in a bonded manner with the first profile body 101. To this end, the first profile body 101 exhibits a fastening area 119, in which a fastening aperture 121 is executed. The fourth profile body end 115-2 of the second profile body 113 is inserted inside the fastening area 119 of the first profile body 101. A fastening element 123, in particular a fastening bolt or fastening rivet, is incorporated in the fastening aperture 121, in order to fasten the second profile body 113 to the first profile body 101.

An effective combination of two extruded profiles in the inside of the wheel control arm 100 can be ensured by means of the connection of the first profile body 101 with the second profile body 113. A particularly effective arrangement of the profile body 101, 113 in the wheel control arm 100 can thereby be achieved, to provide for a higher mechanical resistance of the wheel control arm 100 in an accident of the vehicle.

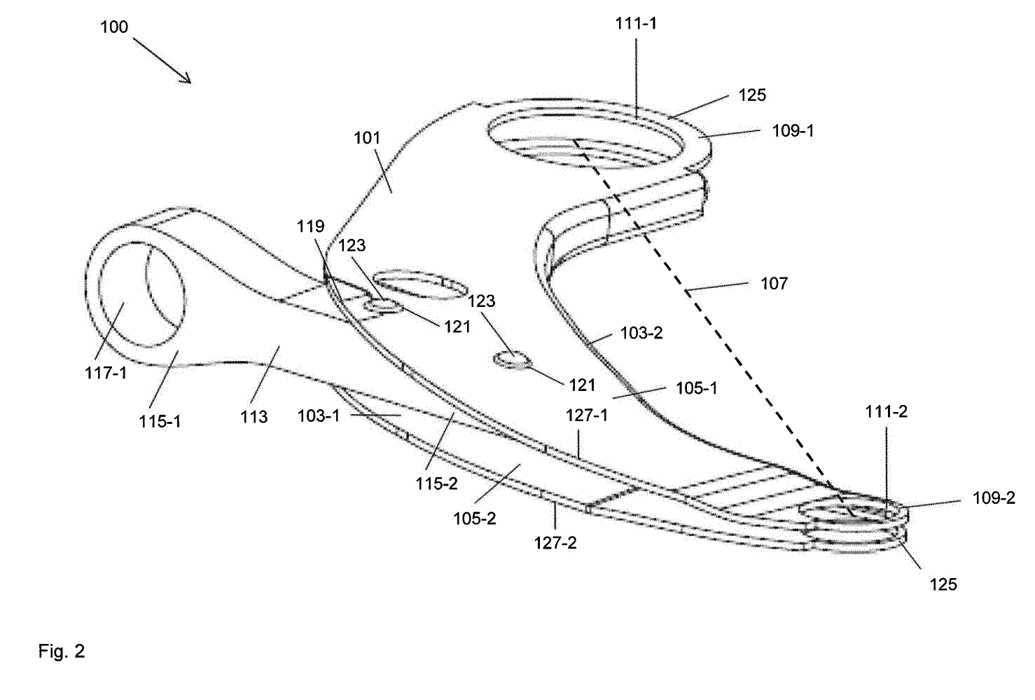

FIG. 2 shows the wheel control arm 100 according to the first example in an oblique view. The first narrow end 103-1 of the first profile body 101 is open and the second narrow end 103-2 of the first profile body 101 is closed. The first profile body 101 hereby exhibits a U-shaped profile, with a first profile wall 127-1, which forms the first broadside 105-1 of the first profile body 101, and with a second profile wall 127-2, which forms the second broadside 105-2 of the first profile body 101.

The first profile wall 127-1 and the second profile wall 127-2 lie facing one another and are formed as flat profile walls 127-1, 127-2. The first broadside 105-1 and the second broadside 105-2 taper down from a first profile body end 109-1 to a second profile body end 109-2.

A distance between the broadsides 105-1, 105-2 facing one another reduces along the longitudinal axis 107 of the profile body of the first profile body 101 from the first profile body end 109-1 to the second profile body end 109-2. Additionally, a cross-sectional area of the first profile body 101 reduces in the same direction along the longitudinal axis 107 of the profile body.

The first profile body end 109-1 exhibits a first bearing seat 111-1 for the fastening of the wheel control arms 100 to a vehicle component. The second profile body end 109-2 exhibits a second bearing seat 111-2 for the fastening of the wheel control arms 100 to a wheel carrier.

The wheel control arm 100 furthermore exhibits a second profile body 113, which exhibits a third profile body end 115-1 and a fourth profile body end 115-2. The third profile body end 115-1 exhibits hereby a third, sleeve-shaped bearing seat 117-1 for the fastening of the wheel control arm 100 to the vehicle component. The fourth profile body end 115-2 of the second profile body 113 is inserted in the open first narrow end 103-1 of the first profile body 101, in particular between the first profile body end 109-1 and the second profile body end 109-2 in the open first narrow end 103-1 of the first profile body 101.

The third bearing seat 117-1 executes a press fit for a bearing, whereby a pivot bearing is arranged in the third bearing seat, in particular, an elastomer bearing or a rubber bearing. The pivot bearing can hereby be without an outer sleeve since the third bearing seat 117-1 hereby forms an outer sleeve of the pivot bearings.

The third bearing seat 117-1 is designed to be laterally free and is arranged at an angle to the first and second bearing seats 111-1 and 111-2.

The first and second bearing seat 111-1, 111-2 are formed with a protruding circumferential collar 125 by means of a reshaping of the respective profile ends 109-1, 109-2.

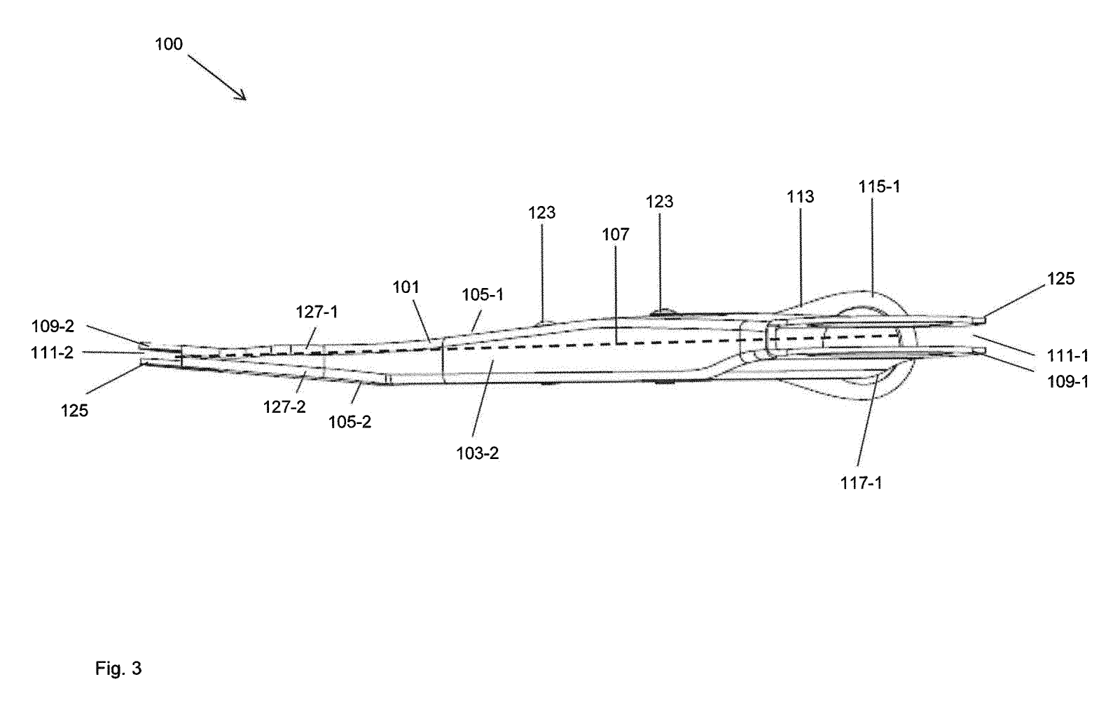

FIG. 3 shows a wheel control arm 100 according to the first example in a side view. The second narrow end 103-2 of the first profile body 101 is closed. The open first narrow end 103-1 of the first profile body 101, which is formed by means of a first and second profile wall 127-1, 127-2, is not visible in the view chosen in FIG. 3. The first profile wall 127-1 forms the first broadside 105-1 of the first profile body 101 and the second profile wall 127-2 forms the second broadside 105-2 of the first profile body 101.

The first bearing seat 111-1 of the first profile body ends 109-1 for the fastening of the wheel control arm 100 to a vehicle component and the second bearing seat 111-2 of the second profile body end 109-2 for the fastening of the wheel control arm 100 to a wheel carrier are executed with a protruding circumferential collar 125 by means of a reshaping of the respective profile body ends 109-1, 109-2.

The fourth profile body end 115-2 of the second profile body 113 that is not represented in FIG. 3 is inserted in the open first narrow end 103-1 of the first profile body 101, and fastened by means of a fastening means 123 to the first profile body 101.

The third bearing seat 117-1 is arranged on the third profile body end 115-1.

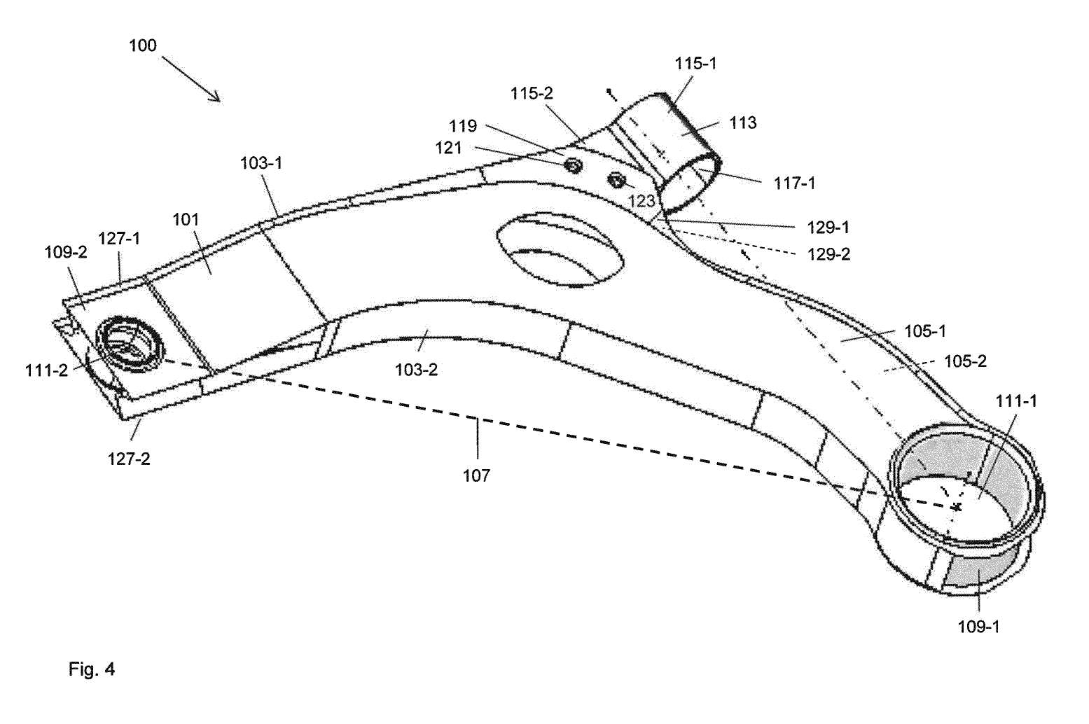

FIG. 4 shows a wheel control arm according to a second example in an oblique view. The wheel control arm 100 according to the second example exhibits a closed first narrow end 103-1 and a closed second narrow end 103-2. The first profile body 101 hereby exhibits a closed profile, with a first profile wall 127-1, which forms the first broadside 105-1 of the first profile body 101, and with a second profile wall 127-2, which forms the second broadside 105-2 of the first profile body 101.

The first profile wall 127-1 and the second profile wall 127-2 face one another and are formed as fiat profile walls 127-1, 127-2. The first broadside 105-1 and the second broadside 105-2 taper down from a first profile body end 109-1 to a second profile body end 109-2.

The distance between the broadsides 105-1, 105-2 which face one another reduces along the longitudinal axis 107 of the profile body of the first profile body 101 from the first profile body end 109-1 to the second profile body end 109-2. Additionally, a cross-sectional area of the first profile body 101 reduces in the same direction along the longitudinal axis 107 of the profile body.

The first profile body end 109-1 exhibits a first bearing seat 111-1 for the fastening of the wheel control arms 100 to a vehicle component. The second profile body end 109-2 exhibits a second bearing seat 111-2 for the fastening of the wheel control arms 100 to a wheel carrier.

The wheel control arm 100 furthermore exhibits a second profile body 113, which exhibits a third profile body end 115-1 and a fourth profile body end 115-2. The third profile body end 115-1 hereby exhibits a third, sleeve-shaped bearing seat 117-1 for the fastening of the wheel control arms 100 to the vehicle component. The broadsides 105-1, 105-2 that face one another respectively exhibit a fastening collar 129-1, 129-2, whereby the fastening collars 129-1, 129-2 face one another.

The fourth profile body end 115-2 of the second profile body 113 is inserted between the fastening collars 129-1, 129-2 of the first profile body 101 and thereby between the broadsides 105-1, 105-2 facing one another.

A third bearing seat 117-1 on the first profile body end 115-1 of the second profile body 113 executes a press fit for a bearing, whereby a pivot bearing, in particular, an elastomer bearing and a rubber bearing are arranged in the third bearing seat. The pivot bearing can hereby be without an outer sleeve, since the third bearing seat 117-1 hereby forms an outer sleeve of the pivot bearing.

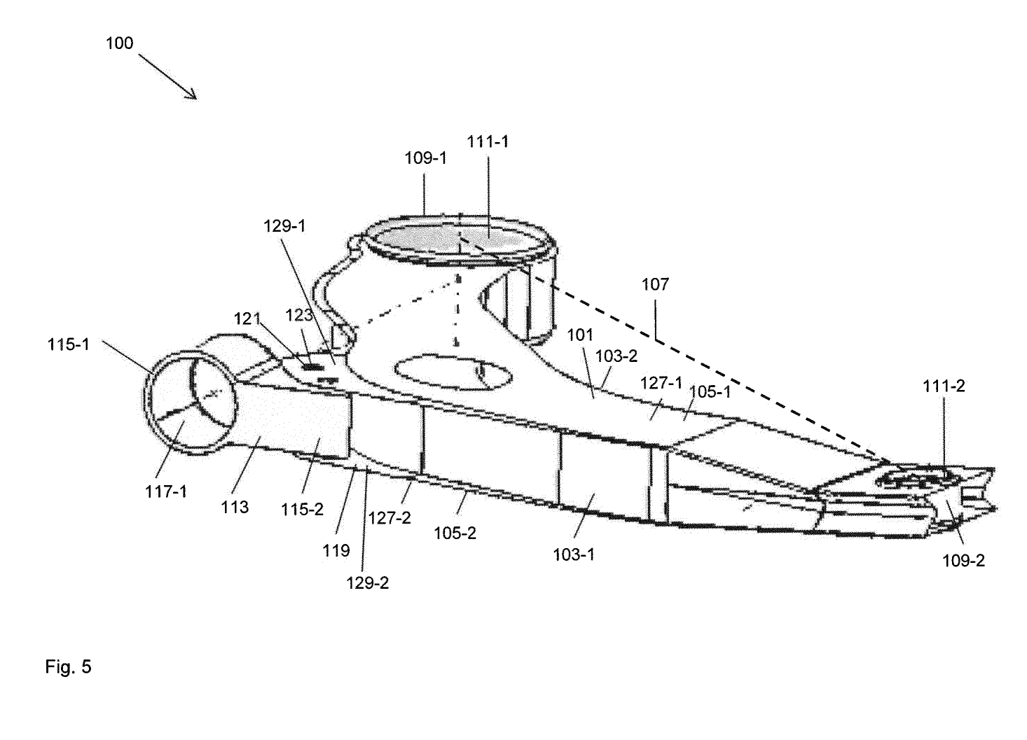

FIG. 5 shows a wheel control arm according to the second example in a side view. The first and second narrow end 103-1, 103-2 of the first profile body 101 are closed. The first profile wall 127-1 forms the first broadside 105-1 of the first profile body 101 and the second profile wall 127-2 forms the second broadside 105-2 of the first profile body 101.

The first profile body 101 exhibits a first bearing seat 111-1 of the first profile body end 109-1 for the fastening of the wheel control arms 100 to a vehicle component and exhibits a second bearing seat 111-2 of the second profile body end 109-2 for the fastening of the wheel control arms 100 to a wheel carrier.

The fourth profile body end 115-2 of the second profile body 113 is inserted between fastening collars 129-1, 129-2 of the broadsides 105-1, 105-2 of the first profile body 101 facing one another, and the fourth profile body end 115-2 is attached by means of fastening means 123 to the first profile body 101.

The third bearing seat 117-1 is arranged on the third profile body end 115-1.

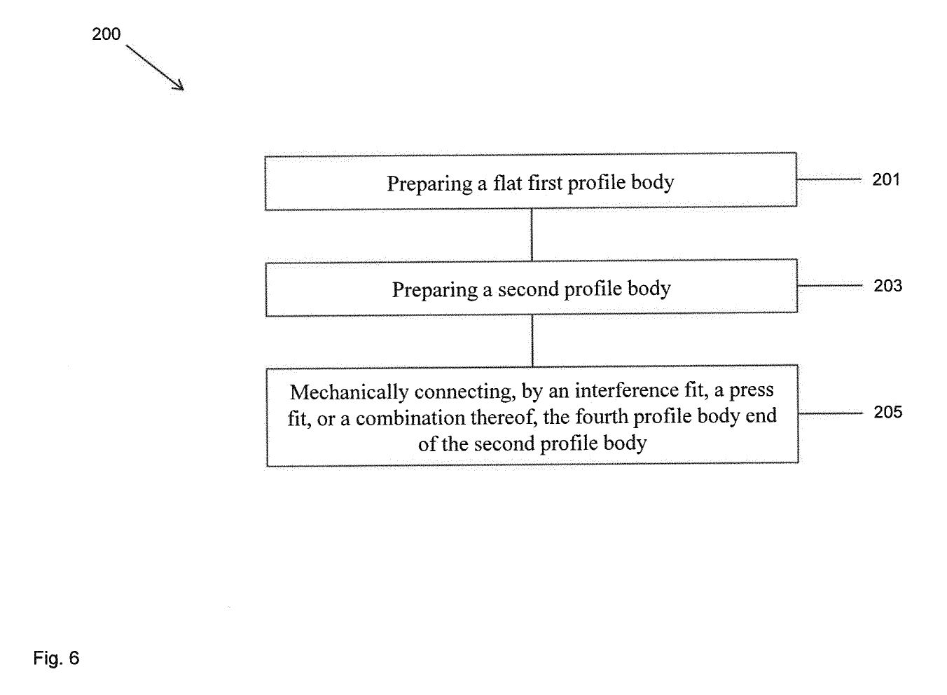

FIG. 6 shows a schematic representation of a method 200 for the manufacturing of a wheel control arm 100 for a wheel suspension.

The method 200 comprises as first step, the preparation 201 of a first profile body 101, that is executed flat with a first narrow end 103-1 and a second narrow end 103-2 which extends opposite the first narrow end 103-1, as well as with broadsides 105-1, 105-2 facing one another, a first profile body end 109-1 and a second profile body end 109-2, whereby the first profile body end 109-1 exhibits a first bearing seat 111-1 for the fastening of the wheel control arm 100 to a vehicle component, and whereby the second profile body end 109-2 exhibits a second bearing seat 111-2 for the fastening of the wheel control arm 100 to a wheel carrier, whereby the first profile body 101 is curved along a longitudinal axis 107 of a profile body around the first narrow end 103-1.

The method 200 comprises as second step, the preparation 203 of a second profile body 113, which exhibits a third profile body end 115-1 and a fourth profile body end 115-2, whereby the third profile body end 115-1 exhibits a third bearing seat 117-1 for the fastening of the wheel control arms 100 to the vehicle component.

The method 200 comprises as third step, the mechanical connection 205, in particular by means of an interference and/or press fit, of the fourth profile body ends 115-2 of the second profile body 113 with the broadsides 105-1, 105-2 of the first profile body 101, that face one another.

### REFERENCE NUMBER LIST

100 Wheel control arm
101 First profile body
103-1 First narrow end
103-2 Second narrow end
105-1 First broadside
105-2 Second broadside
107 Longitudinal axis of the profile body
109-1 First profile body end
109-2 Second profile body end
111-1 First bearing seat
111-2 Second bearing seat
113 Second profile body
115-1 Third profile body end
115-2 Fourth profile body end
117-1 Third bearing seat
119 Fastening area
121 Fastening aperture
123 Fastening element
125 Collar
127-1 First profile wall
127-2 Second profile wail
129-1 First fastening collar
129-2 Second fastening collar
200 Method for the manufacturing of a wheel control arm
201 First method step: preparation of a first profile body
203 Second method step: preparation of a second profile body
205 Third method step: connection of the fourth profile body ends with the first profile body

What is claimed is:

1. A wheel control arm for a wheel suspension in a vehicle, comprising:
a flat first profile body, comprising:
a first narrow end and a second narrow end, wherein the second narrow end extends opposite the first narrow end;
broadsides facing one another;
a first profile body end and a second profile body end, wherein the first profile body end comprises a first bearing seat configured to fasten the wheel control arm to a vehicle component, and wherein the second profile body end comprises a second bearing seat configured to fasten the wheel control arm to a wheel carrier, wherein the first profile body is curved along a longitudinal axis of a profile body around the first narrow end; and
a second profile body, comprising:
a third profile body end and a fourth profile body end, wherein the third profile body end comprises a third bearing seat configured to fasten the wheel control arm to the vehicle component, wherein the second profile body is mechanically connected with the fourth profile body end and with the broadsides of the first profile body that face one another.

2. The wheel control arm according to claim 1, wherein the second profile body extends radially from the first narrow end.

3. The wheel control arm according to claim 1, wherein the broadsides facing one another each comprise a protruding fastening collar, wherein the fastening collars face one another, and wherein the fourth profile body end is inserted between the fastening collars, and wherein the first narrow end is closed.

4. The wheel control arm according to claim 1, wherein the first narrow end is at least partially open, and wherein the fourth profile body end is laterally inserted in the first profile body through the first open narrow end.

5. The wheel control arm according to claim 1, wherein the first narrow end is open and the second narrow end is closed, and wherein the fourth profile body end is laterally inserted in the open first narrow end between the first profile body end and the second profile body end of the first profile body.

6. The wheel control arm according to claim 1, wherein the first profile body comprises a U-shaped or closed profile with profile walls facing one another that form the broadsides of the first profile body, and wherein the first narrow end is or the first and second narrow etuis are formed by the front side or the front sides of the profile walls facing one another.

7. The wheel control arm according to claim 1, wherein the first profile body is connected by interference fit, press fit, in a bonded manner, or some combination thereof with the second profile body.

8. The wheel control arm according to claim 1, wherein the first profile body comprises a fastening area, wherein the fourth profile body end is inserted inside the fastening area, and wherein the fastening area comprises at least one fastening aperture configured to seat a fastening element.

9. The wheel control arm according to claim 1, wherein the broadsides of the first profile body taper down to the second profile body end of the first profile body.

10. The wheel control arm according to claim 1, wherein the broadsides of the first profile body are formed by profile walls facing one another.

11. The wheel control arm according to claim 1, wherein at least one of the bearing seats is formed in a sleeve-like shape.

12. The wheel control arm according to claim 11, wherein at least one of the bearing seats is formed with at least one protruding circumferential collar by a reshaping of the respective profile body ends and forms an outer bearing collar of a bearing.

13. The wheel control arm according to claim 1, wherein the third bearing seat is configured to form a press fit for a bearing.

14. The wheel control arm according to claim 1, wherein a pivot bearing is arranged in the third bearing seat, wherein the pivot bearing is without an outer sleeve, and wherein the third bearing seat forms an outer sleeve of the pivot bearing.

15. The wheel control arm according to claim 1, wherein a distance between the broadsides facing one another reduces along the longitudinal axis of a body profile of the first profile body, and wherein a cross-sectional area of the first profile body reduces along the longitudinal axis of the profile body.

16. The wheel control arm according to claim 1, wherein the first profile body, the second profile body, or a combination thereof are made in one piece out of a metal as an extruded profile or out of a fiber reinforced plastic.

17. The wheel control arm according to claim 1, wherein the wheel control arm is a wishbone.

18. A method for manufacturing of a wheel control arm for a wheel suspension in a vehicle, comprising:
preparing a flat first profile body that comprises a first narrow end and a second narrow end that extends opposite the first marrow end and with broadsides that face one another, and a first profile body end and a second profile body end, wherein the first profile body end comprises a first bearing seat configured to fasten the wheel control arm to a vehicle component, and wherein the second profile body end comprises a second bearing seat configured to fasten the wheel control arm to a wheel carrier, wherein the first profile body is curved along a longitudinal axis of a profile body around the first narrow end;
preparing a second profile body comprising a third profile body end and a fourth profile body end, wherein the third profile body end comprises a third bearing seat configured to fasten the wheel control arm to the vehicle component; and
mechanically connecting, by an interference fit, a press fit, or a combination thereof, the fourth profile body end of the second profile body with the broadsides of the first profile body that face one another.

19. The method according to claim 18, wherein the first profile body is curved around the first narrow end from a straight semi-finished profile body.

20. The method according to claim 18, further comprising:
cutting the first profile body in a lateral direction.
